(19) United States
(12) Patent Application Publication
(10) Pub. No.: US 2004/0245356 A1
(43) Pub. Date: Dec. 9, 2004

(54) Nozzle for generating high-energy cavitation

(75) Inventors: Ilia Kondratiev, Gainesville, FL (US); John Fulkerson, Gainesville, FL (US); Igor Kamenkov, Simferpol (UA)

Correspondence Address: BROWDY AND NEIMARK, P.L.L.C., 624 NINTH STREET, NW, SUITE 300, WASHINGTON, DC, 20001-5303, US

(73) Assignee: Arkaim, Inc., Gainesville, FL

(21) Appl. No.: 10/849,837

(22) Filed: May 21, 2004

Related U.S. Application Data
(60) Provisional application No. 60/472,142, filed on May 21, 2003.

(51) Int. Cl. B05B 1/00

(52) U.S. Cl. 239/589

(57) ABSTRACT

A cavitation nozzle comprising a first cylindrical section that is connected to a second cylindrical section, which is connected to a diffuser. In the cavitation nozzle of the present invention, the diameter of the second cylindrical section is greater than the diameter of the first cylindrical section. The inner surface of the first diffuse section is rifled. An optimal magnet can be placed around either the first or the second cylindrical section.

### CROSS REFERENCE TO RELATED APPLICATIONS

The present application claims priority from provisional application Ser. No. 60/472,142, filed May 21, 2003, the entire contents of which are hereby incorporated by reference.

### FIELD OF THE INVENTION

The present invention relates to a nozzle for inducing hydrosonic cavitation in liquids and for methods of generating-surface energy using this nozzle.

### BACKGROUND OF THE INVENTION

The boiling points of liquids are greatly dependent upon the pressure of the liquid. The boiling temperature drops with decreasing pressure. Under a strong vacuum, such as may occur at high velocities, or when the ambient pressure drops, pressure can locally decrease so that the liquid boils. Such conditions frequently occur in hydrodynamic flow machines, such as pumps, turbines, propellers, for instance, when turbine blades are passed, etc. This results in what is known as cavitation. In cavitation, vacuum, vapor and gas bubbles are created in the liquid and cause the formation of voids. A subsequent pressure rise is accompanied by rapid collapse of the bubbles, so-called impact condensation.

Although cavitation is in many cases undesirable because of the possibility of erosion of the material around which the flow occurs, as well as the considerable noise caused by cavitation, it may be usefully applied in other instances, such as an aid in destroying germs in wastewater.

In cavitation, a certain amount of ultrasonic energy is introduced into a liquid. However, conventional means of generating cavitation by means of ultrasonic energy involve complex equipment. Another means for generating cavitation is by means of a cavitator, which is substantially similar to a centrifuge, but this is also relatively complex and expensive. Also known are cavitation generators that use vibrating pistons (magnetostriction), which function on the basis of ultrasonic energy.

The surface energy of a liquid can be increased by increasing the surface between the liquid and the fluid which the liquid encloses (e.g., air). When bubbles are formed by introducing energy into a fluid, the dividing surface of the fluid will be significantly decreased, so that the fluid has significantly less potential energy after the bubbles formed collapse. Part of the potential energy released from the bubbles' collapsing is transformed into heat energy, which can cause temperatures of about 10,000° K to about 20,000° K at the point of collape.

Another feature of collapsing bubbles is generation of a mechanical force. A cavitation bubble has a very low pressure, so at the time it collapses it creases a very strong force on the medium into which it collapses.

High velocity jets are used, for example, in air or liquid environments for cutting soil in dredging operations, as well as for cutting and moving materials such as in mining.

Modern cleaning systems often use a fluid jet to remove rust, scale, or coatings from a surface to be cleaned. Typically, these surfaces are cleaned by the application of a fluid which carries an abrasive substance, such as sand, particularly when it is desired to clean a corroded or coated metal surface down to bare metal. In many prior art systems, use of a high-pressure fluid without an abrasive would not effectively clean the surface.

It is known in the art to use cavitation to increase the cleaning power of a fluid jet. Essentially, the principle of cavitation involves lowering the pressure of a fluid below its vapor pressure. As the fluid reaches pressures below its vapor pressure, bubbles of vaporized fluid form in the jet. As the jet contacts a surface to be cleaned, these bubbles collapse and release kinetic energy. This energy can be used to remove rust, scale, or other coatings. The rust, scale, or other coating is removed because when the cavitation bubbles collapse, the fluid into which the bubbles collapse is subjected to great forces, so that the fluid is able to tear particles off the surface that are contacted by these bubbles.

Problems exist with prior art nozzles that are used to produce cavitation because, for the nozzle to produce substantial cavitation bubbles, the fluid passing through the nozzle had to be under much higher pressures than can be achieved with conventional nozzles.

Cavitation nozzles have been used for water remediation and purification. In this case, a stream of wastewater is pumped through a cavitation nozzle, ionizing the water, which oxidizes the contaminants.

### SUMMARY OF THE INVENTION

It is an object of the present invention to overcome the deficiencies in the prior art.

It is another object of the present invention to provide a cavitation nozzle for use in a liquid medium.

It is a further object of the present invention to provide a cavitation nozzle that can be used for cleaning surfaces.

It is still another object of the present invention to provide a cavitation nozzle for demolition of hard surfaces.

It is a further object of the present invention to provide a cavitation nozzle that can be used to disinfect liquids.

It is still another object of the present invention to provide a cavitation nozzle that can be used to generate heat in liquids.

It is yet another object of the present invention to provide a cavitation nozzle that can be used to disperse liquids, or to combine polar and non-polar liquids to form a high quality emulsion with one pass through the nozzle without significantly elevating the temperature of the liquids.

The cavitation nozzle of the present invention has an intake area connected to a first cylindrical section and a second cylindrical section or Helmholtz resonator. The diameter of the first cylindrical section is smaller than the diameter of the second cylindrical section. A conical diffuser is connected to the second cylindrical section. The diameter of the inlet of the diffuser is larger than the diameter of the first cylindrical section but smaller than the diameter of the second cylindrical section.

The inner surface of the cavitation nozzle contains connected cylinders and a conical diffuser. The surface of the first cylindrical section is rifled. A magnet is optionally placed outside the first or the second cylindrical section, or outside both cylindrical sections.

### BRIEF DESCRIPTION OF THE DRAWING

FIG. 1 is a side section view of the cavitation-nozzle of the present invention.

### DETAILED DESCRIPTION OF THE INVENTION

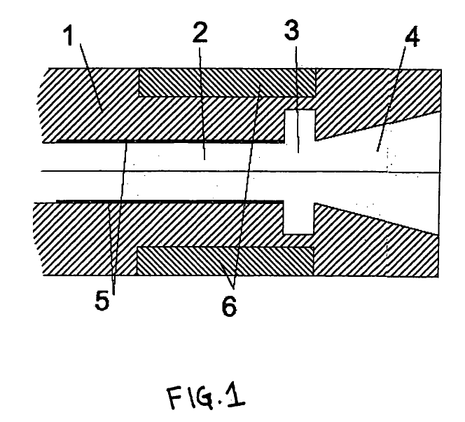

FIG. 1 shows a side section view of a cavitation nozzle 1 according to the present invention. The cavitation nozzle 1 has a first cylindrical section 2 and a second cylindrical section 3. The first cylindrical section 2 has a smaller diameter than the second cylindrical section 3. A conical diffuser section 4 interfaces with the second cylindrical section 3.

Spiral rifles 5 are located on the inside wall of the first cylindrical section 2. An annular magnet 6 is optionally located around the outside of at least one of the first cylindrical section 2 and the second cylindrical section 3.

In use, the nozzle 1 is placed into a fluid such as water. Fluid under pressure enters first cylindrical section 2. Rifling of the wall of the first cylindrical section 5 causes the fluid to swirl and lowers the hydrostatic pressure of the fluid. The velocity of the fluid increases and the nuclei of the future cavitation bubbles form in first cylindrical section 2 under certain conditions, namely, the relationship of the velocity of the flow and the difference between the pressures inside and outside of the nozzle.

The fluid and nuclei of cavitation bubbles move into the second cylindrical section 3, as the fluid flow can be influenced by the magnetic field created by the optional magnet 6. Because of the combined effects of the magnetic field and the centripetal force of the swirling flow, and the resonance induced by the Helmholtz resonator, the number of nuclei increases dramatically in the second cylindrical section 3. The spinning motion imparted to the nuclei by the rifling of the first cylindrical section 2 and the influence of the magnetic field also causes an increase in potential energy of surface tension of the nuclei.

The nuclei pass through the diffuser section 4 where the hydrostatic pressure increases. This increase in pressure initiates formation of the bubbles. The stream of cavitation bubbles is directed at a surface or liquid as desired. The collapse of the bubbles near a surface provides sufficient force to the surface to remove foreign substances attached to the surface to remove the substances from the surface. The collapse of the bubbles in a liquid provides heat to the liquid.

In another embodiment of the nozzle of the present invention, the optional magnet 6 may surround the outside of the first cylindrical section 2, or the outside of both cylindrical sections. While any type of magnet can be used, an annular magnet provides the greatest magnetic field around the first or second cylinder.

As in the nozzle disclosed in U.S. Application Ser. No. 60/472,142, filed May 21, 2003, the difference in pressure between the first cylindrical section 2 and the second cylindrical section 3 leads to generation of cavitation bubbles in the stream starting in the diffuser 4. In the second cylindrical section 3, the nuclei of cavitation bubbles grow in numbers (quantities), then flow through diffuser 4 where the cavitation bubble form. As the cavitation bubbles enter the diffuser, they enter a zone of increased hydrostatic pressure of the surrounding medium. The cavitation bubbles are compressed until forces of surface tension cannot sustain the pressure of the surrounding medium, and the bubbles then collapse.

Cavitation bubbles are transferred by the liquid stream from the nozzle to the surrounding liquid medium, forming a congested zone of cavitation bubbles, similar to a “flame” of bubbles, separated from the nozzle 1. Collapse of cavitation bubbles at a surface can cause erosion of that surface. However, in the cavitation nozzle of the present invention, the cavitation bubbles move through the diffuser (4) without impinging on the nozzle and thus do not erode the nozzle. The stream of cavitation bubbles from the jet of the nozzle pulses with a frequency related to the pressure and the speed, depending on the size and ratios of the elements of the nozzle.

The intensity of the cavitational “flame” at the tip of the immersed cavitation nozzle is determined by the change in the ratio between the internal hydrostatic pressure and the external pressure. The hydosonic frequency is also dependent on this ratio.

The energy imparted to the liquid by the collapse of cavitation bubbles emerging from the nozzle can be used to impart heat to the liquid.

The cavitation nozzle of the present invention can also be used to clean submerged structures, such as bridge piers and pilings, petroleum drilling and production platform jackets and legs, and marine pier pilings.

The cavitation nozzle of the present invention can be used to clean almost any type of surface, including but not limited to steel and ferrous metals, non-ferrous metals and alloys, fiberglass, concrete, plastics, rubber, wood, and other composite materials.

The cavitation nozzle of the present invention is superior to conventional nozzles that use high water pressure because the high energy cavitation stream delivers more force than conventional nozzles. For example, the high energy cavitation nozzles of the present invention can be used for cleaning surfaces, such as ship's hulls, rudders, propellers, and kingstons, to remove biological growth on the surface with one pass of the cleaning tools. This makes it possible to avoid the use of poisonous compounds and paints to prevent biological growth on ships hulls and bottoms, as this growth can be easily removed with one pass of the nozzle over a ship's surface.

The cavitation nozzle of the present invention can be used in any situation in which a stream of high energy fluid is needed. Films can be removed from surfaces such as the surfaces of hydraulic engineering structures, including hydroelectric power stations, coastal structures, underwater nets, sea platforms for gas and oil recovery, offshore platforms, turbine blades, sewage tanks, pipes, etc. The cavitation nozzle of the present invention produces a high energy stream of cavitation bubbles that can be used for demolition of materials such as concrete, or for cleaning biological or chemical matter from surfaces. The high energy cavitation bubbles produced by the cavitation nozzle of the present invention can be used to disperse and sterilize liquids, as well as combining polar and non-polar fluids into a high quality emulsion.

Additionally, because of the great amount of heat generated by the collapsing bubbles, the nozzle of the present invention can be used to heat water or other fluids.

The cavitation nozzle of the present invention can be used to clean man-made water reservoirs, including but not limited to swimming pools, pre-stressed concrete water tanks, of any type of surface. These surfaces include but are not limited to gunite, marsite, concrete, fiberglass and plastic.

The cavitation nozzle of the present invention can also be used to clean submerged structures, such as bridge piers and pilings, petroleum drilling and production platform jackets and legs, and marine pier pilings.

The cavitation nozzle of the present invention can also be used to clean the interior of pipe, tubing, tanks, and pressure vessels, as well as raw wool and cotton. To clean fabrics or fibers, such as raw wool or cotton, the material to be cleaned is submerged in water or other suitable liquid and a stream of cavitating liquid is directed at the material, removing foreign particles and dirt from the material.

The cavitation nozzle of the present invention is also well suited to sanitary applications, including but not limited to destruction of black algae and other microorganisms in swimming pools and other reservoirs. As noted above, the heat and pressure generated by the cavitation nozzle of the present invention can be used to disinfect potable water as well as swimming pool water. The cavitation nozzle of the present invention can be used to destroy microorganisms and other living creatures the same size or smaller than the cavitation bubble in bilge water on ships and boats. Likewise, the cavitation nozzle of the present invention that generates heat or pressure from the bubbles collapsing as well as ultrasound, can be used to disinfect waste water and sewage.

The cavitation nozzle of the present invention can be used to separate crude petroleum and petroleum products into their fractions, as well as to separate milk into milk fat and other products.

The force of the cavitation nozzle of the present invention is such that the nozzle can be used to cut concrete or other hard materials under water.

The foregoing description of the specific embodiments will so fully reveal the general nature of the invention that other can, by applying current knowledge, readily modify and/or adapt for various application such specific embodiments without undue experimentation and without departing from the generic concept. Therefore, such adaptations and modifications should be and are intended to be comprehended within the meaning and range of equivalents of the disclosed embodiments.

It is to be understood that the phraseology or terminology employed herein is for the purpose of description and not of limitation. The means and materials for carrying out various disclosed functions may take a variety of alternative forms without departing from the invention.

Thus, the expressions “means to . . . ” and “means for . . . ” as may be found in the specification above and/or in the claims below, followed by a functional statement, are intended to define and cover whatever structural, physical, chemical, or electrical element or structures which may now or in the future exist for carrying out the recited function, whether or nor precisely equivalent to the embodiment or embodiments disclosed in the specification above. It is intended that such expressions be given their broadest interpretation.

What is claimed is:

1. A cavitation nozzle comprising a tube having a first internal cylindrical section;
Said first internal cylindrical section is connected to a second cylindrical section;
The interior of said first internal cylindrical section is provided with rifles;
The diameter of the first cylindrical section is smaller than the diameter of the second cylindrical section; and
The second cylindrical section is connected to a diffuser having an internal conical structure through which cavitation bubbles exit the nozzle.

2. The cavitation nozzle according to claim 1 wherein a magnet is located outside the first cylindrical section.

3. The cavitation nozzle according to claim 1 wherein a magnet is located outside the second cylindrical section.

4. The cavitation nozzle according to claim 1 wherein a magnet is located outside the first cylindrical section and the second cylindrical section.

5. A method for cleaning a surface comprising:
a. introducing water or other liquid into a cavitation nozzle body which contains a first cylindrical section and a second cylindrical section and a diffuser, wherein the first cylindrical section includes rifles in the inner surface thereof;
b. whereby when liquid is flowed through the cavitation nozzle the nuclei of cavitation bubbles form in the first cylindrical section and move into the second cylindrical section;
c. cavitation bubbles form in the diffuser section wherein the hydrostatic pressure increases, and
d. a stream of cavitation bubbles is directed at the surface, whereby the collapse of bubbles near the surface cleans the surface by removing foreign substances from the surface.

6. The method according to claim 5 wherein a magnet is placed outside the first cylindrical section.

7. The method according to claim 5 wherein a magnet is placed outside the second cylindrical section.

8. The method according to claim 5 wherein a magnet is placed outside both the first cylindrical section and the second cylindrical section.

9. A method for heating a liquid comprising:
a. Introducing a liquid into a cavitation nozzle body which contains a first cylindrical section, a second cylindrical section and a diffuser, wherein the first cylindrical section includes rifles in the inner surface thereof, and an optional magnet is placed outside at least one of the first cylindrical section and the second cylindrical section;
b. Whereby nuclei of cavitation bubbles form in the first cylindrical section and move into the second cylindrical section;
c. Cavitation bubbles then form in the diffuser section wherein the hydrostatic pressure increases; and
d. A stream of cavitation bubbles is directed into the liquid, and collapse of the bubbles heats the liquid by imparting kinetic energy from the collapse of the bubbles to the liquid.

10. The method according to claim 9 wherein the liquid is water.

11. A method for disinfecting a surface or a fluid comprising:
a. Introducing a liquid into a cavitation nozzle body which contains a first cylindrical section and a second cylindrical section and a diffuser, wherein the first cylindrical section includes rifles in the inner surface thereof, and an optional magnet is placed outside at least one of the first cylindrical section and the second cylindrical section;
b. whereby nuclei of cavitation bubbles form in the first cylindrical section and move into the second cylindrical section;
c. bubbles form in the diffuser section, wherein the hydrostatic pressure increases; and
d. a stream of cavitation bubbles is directed at the surface or into the fluid and the collapse of the bubbles near the surface or in the fluid removes and destroys microorganisms on the surface or in the fluid.
